(19) United States
(12) Patent Application Publication
(10) Pub. No.: US 2019/0135692 A1
(43) Pub. Date: May 9, 2019

(54) METHOD OF REDUCING STICKINESS OF CEMENTITIOUS COMPOSITIONS

(71) Applicant: GCP Applied Technologies Inc., Cambridge, MA (US)

(72) Inventors: Lawrence L. Kuo, Acton, MA (US); Shuqiang Zhang, Singapore (SG); Hideo KOYATA, Atsugi-shi (JP)

(21) Appl. No.: 15/790,857

(22) Filed: Oct. 23, 2017

(51) Int. Cl. C04B 24/26; C04B 14/06; C04B 7/02

(52) U.S. Cl. CPC C04B 24/2647; C04B 14/06; C04B 2111/00344; C04B 2201/10; C04B 7/02

(57) ABSTRACT

The present invention provides a method and admixture composition for making hydratable cementitious compositions, ones believed to have much less stickiness in comparison to prior methods. Decreased stickiness in concrete mixes means that they are easier to pour or to cast into place, as well as easier to finish. Dispersant carboxylate polymers of the invention having this ability are characterized by possessing two different, relatively short chain lengths of polyalkyleneoxide units and low weight-average molecular weights.

### FIELD OF THE INVENTION

The present invention relates to modification of cementitious compositions; and, more particularly, to the reduction of stickiness in concrete and mortars, which refers to difficulties in placing and finishing cementitious mixes, by using uniquely structured carboxylate copolymers that have different, relatively short lengths of polyalkyleneoxide units as well as low-weight-average molecular weight.

### BACKGROUND OF THE INVENTION

Water-reducing admixtures are known to reduce water amounts needed for plasticizing concrete mixes, such that less water is required for reaching a given slump as compared to untreated concrete. Lower water-to-cement (w/c) ratios are also known to give rise to higher strength concretes without requiring increase in cement amount. Some of the relevant teachings in this respect are as follows.

In EP 0 850 894 B1 (1997), Hirata et al. taught polycarboxylate copolymers which functioned as HRWR dispersants and which were made from polyalkylene glycol ether-based monomers and maleic acid based monomers. This reference disclosed polymers having 1 to 300 oxyalkylene groups and molecular size ranges extending upwards to 100,000.

In U.S. Pat. No. 6,187,841 (2001), Tanaka et al. taught polycarboxylate polymers which functioned as high range water reducing (HRWR) cement dispersants and which were made from (alkoxy)polyalkylene glycol mono(meth)acrylic ester type monomers and (meth)acrylic acid type monomers. This reference appears to emphasize that longer polyethylene glycol chain lengths increase the water-reducing property of the polymer. See e.g., Column 25 at lines 45-47.

In U.S. Pat. No. 6,294,015 (2001), Yamashita et al. (Nippon Shokubai Co., Ltd.) taught cement admixtures wherein a copolymer is obtained by copolymerizing comonomers which included at least two specific polyalkylene glycol (meth)acrylate monomers and having an unsaturated carboxylic acid content of 45 weight % or less, wherein the specific monomers have an average molar number of addition of the oxyalkylene groups, constituting a polyalkylene glycol chain, of 10 or more, and includes terminal aliphatic or alicyclic hydrocarbon group with 1 to 30 carbon atoms. See e.g., U.S. Pat. No. 6,294,015 at column 2, lines 6-18.

In U.S. Pat. No. 6,376,581 (2002), Tanaka et al. taught a polycarboxylic acid type polymer for achieving a high range water reducing ability and preventing slump loss, the polymer having a weight average molecular weight in the range of 10,000 to 500,000 in terms of polyethylene glycol determined by gel permeation chromatography, and having a value determined by subtracting the peak top molecular weight from the weight average molecular weight in the range of 0 to 8,000.

In US Patent Pub. No. 2006/0223914 (2006), Yuasa taught a polycarboxylic acid polymer having both dispersibility and dispersibility retention. The cement admixture is prepared by using polymers having a broad molecular weight distribution wherein the ratio of the high-molecular weight polymer and the low-molecular weight polymer was adjusted. Paragraph [0010]. Preparation also involved at least two steps, wherein the ratios of chain-transfer agent to monomer components was changed by five times or more between the polymerization processes constituting the two steps. Paragraph [0010].

In US Publ. No. 2016/0090323 A1 (2016), Kuo et al. taught methods for plasticizing cementitious mixtures having high water/cement ratio (e.g., at least 0.40 or higher), wherein a polycarboxylate polymer is formed from small-sized, specifically selected monomer constituents to achieve low-to-mid-range water reduction. The polycarboxylate comb type copolymer is described with 5-23 linear repeating ethylene oxide units, and devoid of propylene oxide or higher oxyalkylene groups.

While polycarboxylate comb copolymers increase strength and reduce water amount in concretes, they also tend to induce stickiness. In other words, the concrete becomes difficult to pour or cast into place, and difficult to finish to a smooth surface using a trowel or other implement. This is the case when the water-to-cement ratio is below 0.45, and especially the case when it is below 0.40. Thus, a novel admixture composition and method for reducing stickiness in cementitious mix compositions are desired.

### SUMMARY OF THE INVENTION

The present invention provides a method and admixture composition that minimize stickiness problems in concrete, namely the stickiness issues that are often confronted during placement or finishing of the concrete mix. This is accomplished by employing polycarboxylate comb polymers having particular polyoxyalkylene oxide side chains within an overall specific polymer molecular weight range. The polymers of the invention provide excellent rheological properties while minimizing concrete or mortar stickiness issues.

An exemplary method of the present invention for making a hydratable cementitious composition comprises:

combining with water, cement, and at least one carboxylate copolymer formed from the following monomer components (A), (B), (C), and optionally (D):

(A) a first polyoxyalkylene monomer represented by structural formula:

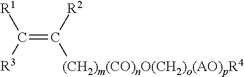

wherein R¹ and R² individually represent hydrogen atom or methyl group; R³ represents hydrogen or C(O)OM group wherein M represents a hydrogen atom or an alkali metal; AO represents an oxyalkylene group having 2 to 4 carbon atoms or mixtures thereof (e.g., wherein 0 represents oxygen and A represents both 2- and 3-carbon alkyl groups); “m” represents an integer of 0 to 2; “n” represents an integer of 0 or 1; “o” represents an integer of 0 to 4; “p” represents an average number of oxyalkylene groups and is an integer from 5 to 35; and R⁴ represents a hydrogen atom or C₁ to C₄ alkyl group;

(B) a second polyoxyalkylene monomer represented by structural formula:

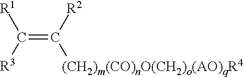

wherein R¹ and R² individually represent hydrogen atom or methyl group; R³ represents hydrogen or C(O)OM group wherein M represents a hydrogen atom or an alkali metal; AO represents an oxyalkylene group having 2 to 4 carbon atoms or mixtures thereof; “m” represents an integer of 0 to 2; “n” represents an integer of 0 or 1; “o” represents an integer of 0 to 4; “q” represents an average number of oxyalkylene groups and is an integer from 20 to 80; and R⁴ represents a hydrogen atom or C₁ to C₄ alkyl group;

(C) an unsaturated carboxylic acid monomer represented by structural formula:

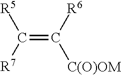

wherein R⁵ and R⁶ individually represent hydrogen atom or methyl group; R⁷ represents hydrogen atom, C(O)OM, C(O)OR⁸, or C(O)NH R⁸ wherein R⁸ represents a C₁ to C₄ alkyl group, and M represents a hydrogen atom or an alkali metal; and, optionally,

(D) an unsaturated, water-soluble monomer represented by structural formula:

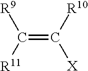

wherein R⁹, R¹⁰, and R¹¹ each independently represent a hydrogen atom, methyl group or C(O)OH; X represents C(O)NH₂, C(O)NHR¹², C(O)NR¹³R¹⁴, O—R¹⁵, SO₃H, C₆H₄SO₃H, or C(O)NHC(CH₃)₂CH₂SO₃H, or mixture thereof, wherein R¹², R¹³, R¹⁴, and R¹⁵ each independently represent a C₁ to C₅ alkyl group;

wherein the molar ratio of component (A) to component (B) is from 15:85 to 85:15, and further wherein the molar ratio of component (C) to the sum of component (A) and component (B) is 90:10 to 50:50.

The present invention also provides an exemplary water-reducing admixture composition for modifying cementitious compositions, comprising a copolymer formed from the above monomer components (A), (B), (C), and optionally (D).

As mentioned above, the water-reducing polymers of the invention provide decreased stickiness in cementitious compositions, such as concrete and mortar mixes, which have been treated with the above water-reducing admixture composition.

### DETAILED DESCRIPTION OF EXEMPLARY EMBODIMENTS

As summarized previously, the present invention provides a method for making cementitious compositions using a copolymer that is believed to confer decreased stickiness in the resultant cementitious material.

The term “cementitious” refers to materials that comprise Portland cement or which otherwise function as a binder to hold together fine aggregates (e.g., sand), coarse aggregates (e.g., crushed gravel), or mixtures thereof. Technically, “cement” refers to hydraulic binder material such as Portland cement which is produced by pulverizing clinker consisting of hydraulic calcium silicates and one or more forms of calcium sulfate (e.g., gypsum) as an interground additive. Typically, Portland cement is combined with one or more supplemental cementitious materials, such as fly ash, granulated blast furnace slag, limestone, natural pozzolans, or mixtures thereof, and provided as a blend. As used herein, the term “cement” will refer to both Portland cement alone and also to combinations of Portland cement with supplemental cementitious materials.

The term “hydratable” as used herein refers to cement and/or cementitious materials that are hardened by chemical interaction with water. Portland cement clinker is a partially fused mass primarily composed of hydratable calcium silicates. The calcium silicates are essentially a mixture of tricalcium silicate (3CaO.SiO₂ “C₃S” in cement chemists notation) and dicalcium silicate (2CaO.SiO₂, “C₂S”) in which the former is the dominant form, with lesser amounts of tricalcium aluminate (3CaO.Al₂O₃, “C₃A”) and tetracalcium aluminoferrite (4CaO.Al₂O₃.Fe₂O₃, “C₄AF”). See e.g., Dodson, Vance H., Concrete Admixtures (Van Nostrand Reinhold, New York N.Y. 1990), page 1.

The term “concrete” as used herein refers generally to a hydratable cementitious mixture comprising water, a fine aggregate (e.g., sand), and a coarse aggregate (e.g., stones), and optionally one or more additional chemical admixtures.

As used herein, the term “copolymer” or “polymer” refers to compounds containing constituents derived or formed from the use of three different monomer components (designated as components “A”, “B”, and “C”) and optionally from the use of four different monomer components (i.e., further including at least one optional monomer designated as “D”), as described in exemplary methods of the invention and cementitious compositions made by the methods of the invention.

In a first exemplary aspect, the invention provides a method for making a hydratable cementitious composition, one having little or no stickiness compared to many prior art polycarboxylate cement dispersant polymers. The method comprises: combining with water, cement, and at least one carboxylate copolymer formed from the following monomer components (A), (B), (C), and optionally (D):

(A) a first polyoxyalkylene monomer represented by structural formula:

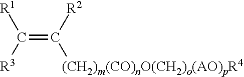

wherein R¹ and R² individually represent hydrogen atom or methyl group; R³ represents hydrogen or C(O)OM group wherein M represents a hydrogen atom or an alkali metal; AO represents oxyalkylene group having 2 to 4 carbon atoms or mixtures thereof; “m” represents an integer of 0 to 2; “n” represents an integer of 0 or 1; “o” represents an integer of 0 to 4; “p” represents an average number of oxyalkylene groups and is an integer from 5 to 35; and R⁴ represents a hydrogen atom or C₁ to C₄ alkyl group;

(B) a second polyoxyalkylene monomer represented by structural formula:

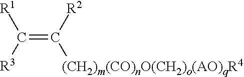

wherein R¹ and R² individually represent hydrogen atom or methyl group; R³ represents hydrogen or C(O)OM group wherein M represents a hydrogen atom or an alkali metal; AO represents an oxyalkylene group having 2 to 4 carbon atoms or mixtures thereof; “m” represents an integer of 0 to 2; “n” represents an integer of 0 or 1; “o” represents an integer of 0 to 4; “q” represents an average number of oxyalkylene groups and is an integer from 20 to 80; and R⁴ represents a hydrogen atom or C₁ to C₄ alkyl group;

(C) an unsaturated carboxylic acid monomer represented by structural formula:

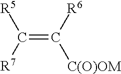

wherein R⁵ and R⁶ individually represent hydrogen atom or methyl group; R⁷ represents hydrogen atom, C(O)OM, C(O)OR⁸, or C(O)NH R⁸ wherein R⁸ represents a C₁ to C₄ alkyl group, and M represents a hydrogen atom or an alkali metal; and, optionally,

(D) an unsaturated, water-soluble monomer represented by structural formula:

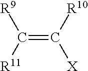

wherein R⁹, R¹⁰, and R¹¹ each independently represent a hydrogen atom, methyl group or C(O)OH; X represents C(O)NH₂, C(O)NHR¹², C(O)NR¹³R¹⁴, O—R¹⁵, SO₃H, C₆H₄SO₃H, or C(O)NHC(CH₃)₂CH₂SO₃H, or mixture thereof, wherein R¹², R¹³, R¹⁴, and R¹⁵ each independently represent a C₁ to C₅ alkyl group; and

wherein the molar ratio of component (A) to component (B) is from 15:85 to 85:15, and further wherein the molar ratio of component (C) to the sum of component (A) and component (B) is 90:10 to 50:50.

In a second aspect, based on the first exemplary aspect described above, the invention provides a method wherein the hydratable cementitious mixture comprises sand aggregates.

In a third aspect, based on any of the first through second exemplary aspects, the invention provides a method wherein the hydratable cementitious mixture comprises stone aggregates.

In a fourth aspect, based on any of the first through third exemplary aspects, the invention provides a method wherein the hydratable cementitious mixture is a concrete having a cement to concrete ratio of at least 340 kg/m³.

In a fifth aspect, based on any of the first through fourth exemplary aspects, the invention provides a method wherein the hydratable cementitious mixture is a concrete having a cement to concrete ratio of at least 400 kg/m³.

In a sixth aspect, based on any of the first through fifth exemplary aspects, the invention provides a method wherein, in the first polyoxyalkylene monomer of component (A), “p” is an integer of 8 to 30.

In a seventh aspect, based on any of the first through sixth exemplary aspects, the invention provides a method wherein, in the first polyoxyalkylene monomer of component (A), “p” is an integer of 10 to 25.

In an eighth aspect, based on any of the first through seventh exemplary aspects, the invention provides a method wherein, in the second polyoxyalkylene monomer of component (B), “q” is an integer of 20 to 65.

In a ninth aspect, based on any of the first through eighth exemplary aspects, the invention provides a method wherein, in the second polyoxyalkylene monomer of component (B), “q” is an integer of 25 to 50.

In a tenth aspect, based on any of the first through ninth exemplary aspects, the invention provides a method wherein the sum of “p” in the first polyoxyalkylene monomer of Component (A) and “q” in the second polyoxyalkylene monomer of component (B) is no more than 100.

In an eleventh aspect, based on any of the first through tenth exemplary aspects, the invention provides a method wherein the sum of “p” in the first polyoxyalkylene monomer of component (A) and “q” in the second polyoxyalkylene monomer of component (B) is no more than 80.

In a twelfth aspect, based on any of the first through eleventh exemplary aspects, the invention provides a method wherein the difference between “q” in the second polyoxyalkylene monomer of component (B) and “p” in the first polyoxyalkylene monomer of component (A) is an integer of at least 8.

In an thirteenth aspect, based on any of the first through twelfth exemplary aspects, the invention provides a method wherein “m”, “n”, and “o” in component (A) or component (B) are integers of 0, 1, and 0, respectively.

In a fourteenth aspect, based on any of the first through twelfth exemplary aspects, the invention provides a method wherein “m”, “n”, and “o” in component (A) or component (B) are integers of 1, 0, and 0, respectively.

In a fifteenth aspect, based on any of the first through twelfth exemplary aspects, the invention provides a method wherein “m,” “n,” and “o” in component (A) or component (B) are integers of 2, 0, and 0, respectively.

In a sixteenth aspect, based on any of the first through fifteenth exemplary aspects, the invention provides a method wherein, in the first and second monomer components (A) and (B), the polyoxyalkylene is polyoxyethylene.

In a seventeenth aspect, based on any of the first through sixteenth exemplary aspects, the invention provides a method wherein, the molar ratio of component (A) to component (B) is from 25:75 to 75:25.

In an eighteenth aspect, based on any of the first through seventeenth exemplary aspects, the invention provides a method wherein the molar ratio of component (A) to component (B) is from 35:65 to 65:35.

In a nineteenth aspect, based on any of the first through eighteenth exemplary aspects, the invention provides a method wherein the molar ratio of component (C) to the sum of component (A) and component (B) is 85:15 to 60:40.

In a twentieth aspect, based on any of the first through nineteenth exemplary aspects, the invention provides a method wherein the molar ratio of component (C) to the sum of component (A) and component (B) is 80:20 to 67:33.

In a twenty-first aspect, based on any of the first through twentieth exemplary aspects, the invention provides a method wherein the at least one carboxylate copolymer further comprises constituent groups derived from polymerization using component (D) monomer, and the molar ratio of constituent groups derived from component (D) to the sum of constituent groups derived from component (A), component (B), and component (C) is 1:99 to 20:80.

In a twenty-second aspect, based on any of the first through twenty-first exemplary aspects, the invention provides a method wherein the at least one carboxylate copolymer has a weight-average molecular weight of 8,000-50,000 as measured by using gel permeation chromatography using polyethylene glycol (PEG) standards and ULTRAHYDROGEL™ 1000, ULTRAHYDROGEL™ 250 and ULTRAHYDROGEL™ 120 columns (wherein processing conditions are as follows: 1% aqueous potassium nitrate as elution solvent, flow rate of 0.6 mL/min., injection volume of 80 μL, column temperature at 35° C., and refractive index detection).

In a twenty-third aspect, based on any of the first through twenty-second exemplary aspects, the invention provides a method wherein the at least one carboxylate copolymer has a weight-average molecular weight of 10,000-40,000.

In a twenty-fourth aspect, based on any of the first through twenty-third exemplary aspects, the invention provides a method wherein the at least one carboxylate copolymer has a weight-average molecular weight of 12,000-30,000.

In a twenty-fifth aspect, based on any of the first through twenty-fourth exemplary aspects, the invention provides a method wherein the weight ratio of water to cement is less than 0.45.

In a twenty-sixth aspect, based on any of the first through twenty-fifth exemplary aspects, the invention provides a method wherein the weight ratio of water to cement is less than 0.40.

In a twenty-seventh aspect, based on any of the first through twenty-sixth exemplary aspects, the invention provides a method wherein the active amount of the carboxylate copolymer is from 0.08 to 0.30% by weight of cement.

In a twenty-eighth aspect, based on any of the first through twenty-seventh exemplary aspects, the invention provides a method wherein the active amount of the carboxylate copolymer is from 0.12 to 0.25% by weight of cement.

In a twenty-ninth aspect, based on any of the first through twenty-eighth exemplary aspects, the method further comprises adding to the cement and water at least one additional admixture chosen from gluconic acid or salt thereof (e.g., sodium gluconate), an alkanolamine (e.g., triethanolamine, triisopropanolamine, diethylethanolamine, etc.), an air detraining agent, an air-entraining agent, and mixtures thereof.

In a thirtieth aspect, based on the twenty-ninth exemplary aspect above, the invention provides a method wherein the at least one additional admixture is mixed with the carboxylate copolymer prior to or when combining with the cement and water. For example, a polycarboxylate (PC) comb-type polymer which is conventionally used as a water-reducing admixture can be incorporated in amounts desired by the admixture formulator or other end user. The PC admixture may be combined with an air entraining admixture, air detraining admixture, or both, in be incorporated in amounts desired by the admixture formulator or other end user.

As an example of air detraining agents (defoamers) which can be employed in the present invention, it is contemplated that air detraining nonionic surfactants as disclosed by Gartner in EP 0 415 799 B1, which include phosphates (e.g., tributylphosphate), phthalates (e.g., diisodecylphthalate), and polyoxypropylene-polyoxyethylene copolymers (which are not deemed to be superplasticizers) (See EP 0 415 799 B1 at page 6, II. 40-53) may be appropriate for use in the present invention.

As another example, U.S. Pat. No. 5,156,679 of Gartner taught use of alkylate alkanolamine salts (e.g., N-alkylalkanolamine) and dibutylamino-w-butanol as defoamer. U.S. Pat. No. 6,139,623 of Darwin et al. disclosed antifoaming agents selected from phosphate esters (e.g., dibutylphosphate, tributylphosphate), borate esters, silicone derivatives (e.g., polyalkyl siloxanes), and polyoxyalkylenes having defoaming properties. U.S. Pat. No. 6,858,661 of Zhang et al. disclosed a tertiary amine defoamer having an average molecular weight of 100-1500 for creating stable admixture formulations. A still further example, U.S. Pat. No. 8,187,376 of Kuo et al., disclosed the use of a polyalkoxylated polyalkylene polyamine defoamer. All of the foregoing references, which are owned by the common assignee hereof, are incorporated herein by reference.

As another example of an air detraining agent believed to be suitable for use in the present invention, the present inventors also mentioned U.S. Pat. No. 6,545,067 of Buchner et al. (BASF) which disclosed butoxylated polyalkylene polyamine for reducing air pore content of cement mixes. The present inventors also mention U.S. Pat. No. 6,803,396 of Gopolkrishnan et al. (BASF) which disclosed low molecular weight block polyether polymers described as containing ethylene oxide and propylene oxide units as detrainers. In addition, the present inventors also mention U.S. Pat. No. 6,569,924 of Shendy et al. (MBT Holding AG) which disclosed the use of solubilizing agents for solubilizing water-insoluble defoamers. The present inventors believe these may be used in admixture formulations with the copolymers of the present invention.

As the present inventors believe that conventional air detraining (defoamer) components may be employed with the polycarboxylate comb polymers described in the present invention. Thus, in further exemplary methods and compositions of the invention, one or more the air detraining agents may be included.

Further compositions and methods of the invention may further comprise or include the use of at least one other agent chosen from (i) non-high range water reducer (non-HRWR) such as lignosulfonate or gluconic acid and its salts; (ii) an alkanolamine such as triethanolamine, triisopropanolamine, diethylisopropanolamine, or mixture thereof; (iii) a second defoamer which is different in terms of chemical structure from the first defoamer employed, (iv) an air-entraining agent such as a higher trialkanolamine such as triisopropanolamine or diethylisopropanolamine; (v) a naphthalene sulfonate, a melamine sulfonate, an oxyalkylene-containing non-HRWR plasticizer, (vi) an oxyalkylene-containing shrinkage reducing agent (which does not function as a HRWR additive), or (vii) a mixture thereof.

In a thirty-first aspect, the invention provides a cementitious composition made by any of the exemplary methods set forth in any of the first through thirtieth exemplary aspects, as described hereinabove. These cementitious compositions may further comprises one or more of the additional, above-mentioned admixtures, which may be used in accordance with the design preferences of admixture formulators and other end users.

Thus, the present invention also relates to hydratable cementitious compositions which are made by combining the comb-type carboxylate polymer (made from components A, B, C, and optionally D), and optional additional chemical admixtures, as just described in the exemplary first through thirtieth exemplary aspects above.

In a thirty-second aspect, the present invention provides a hydratable cementitious composition, which may be based on any of the foregoing first through thirty-first exemplary aspects, wherein the hydratable cementitious composition comprising the water, cement, and the at least one carboxylate copolymer formed from the monomer components (A), (B), (C), and optionally (D) in accordance with the present invention, has decreased stickiness compared to a hydratable cementitious composition comprising water, cement, and a reference carboxylate polymer (commercially available and hence not made in accordance with the present invention).

The reduction of stickiness is quantifiable by showing at least one of the following test results, more preferably at least two of the following tests results, and more preferably all of the following test results:
(A) decreased flow time in terms of concrete flowing out of a slump cone using a modified flow test under ASTM C143M-15a wherein the slump cone is inverted (See Example 2 hereinafter, wherein flow time was shown to have been decreased by nearly half);
(B) decreased relative plastic viscosity (See Example 2 hereinafter);
(C) shorter penetration time (See Example 4 hereinafter); and
(D) shorter V-funnel time (i.e., the time required for concrete to flow through a v-shaped funnel, See Example 5 hereinafter).

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are based on weight or percentage by weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

### Example 1

A three-neck round bottom flask was fitted with a mantle heater, a thermocouple connected to temperature controller and a mechanical stirrer. The reactor was charged with 361 g of de-ionized water, purged with argon gas, then heated to 65° C. A solution of 16.1 g poly(ethylene glycol)methyl ether methacrylate (MPEGMA) having 450 molecular weight polyethylene glycol chain, 106.7 g of poly(ethylene glycol)methyl ether methacrylate (MPEGMA) having 1,100 molecular weight polyethylene glycol chain, 17.3 g of acrylic acid (AA), 1.91 g of 3-mercaptopropionic acid and 176 g of de-ionized water was prepared in advance.

Separately, a solution of 4.87 grams (g) of ammonium persulfate in 50 g of de-ionized water was prepared. Once the temperature of the reactor reached 65° C., both solutions were added drop-wise over a period of 1.5 hours while stirring. After the addition was completed, the reaction was continued for another 2.0 hours at 68° C.-70° C. and then stopped by cooling to ambient temperature. The resulting carboxylate polymer, hereinafter referred to as Polymer 1, was determined to have a weight-average molecular weight of 18,000 as measured by gel permeation chromatography (GPC).

The GPC processing conditions are as follows: 1% aqueous potassium nitrate as elution solvent, flow rate of 0.6 mL/min., injection volume of 80 μL, column temperature at 35° C., and refractive index detection. The GPC columns were ULTRAHYDROGEL™ 1000, ULTRAHYDROGEL™ 250 and ULTRAHYDROGEL™ 120 columns and polyethylene glycols were used for calibration. Table 1 summarizes the results of the carboxylate polymer samples of this invention as well as of the reference samples. Reference 1 and Reference 2 are commercial polycarboxylates containing poly(ethylene glycol)methyl ether methacrylate and methacrylic acid while Reference 3 is a commercial polycarboxylate containing isoprenyl poly(ethylene glycol) ether and acrylic acid.

The results are summarized in Table 1.

TABLE 1

| | MW of | MW of | | | | |
|---|---|---|---|---|---|---|
| | PEG in | PEG in | Mono- | Mono- | Mono- | |
| | Mono- | Mono- | mer | mer | mer | Weight- |
| Polymer | mer | mer | (A) | (B) | (C) | average |
| Description | (A) | (B) | [mol] | [mol] | [mol] | Mw [Da] |
| Polymer 1 | 450 | 1,100 | 0.25 | 0.75 | 2.00 | 18,000 |
| Polymer 2 | 450 | 1,100 | 0.25 | 0.75 | 2.60 | 20,000 |
| Reference 1 | — | 1,000 | — | 1.00 | 4.00 | 10,000 |
| Reference 2 | — | 5,000 | — | 1.00 | 3.40 | 50,000 |
| Reference 3 | — | 2,200 | — | 1.00 | 4.30 | 40,000 |

### Example 2

This example illustrates the stickiness-reducing effect of the carboxylate polymers of the invention by measuring the flow, flow time, and relative plastic viscosity of concrete. The concrete mix design included the following components: Asia OPC bagged cement—110 kg/m3; slag—320 kg/m3; sand—765 kg/m3; stone—940 kg/m3; water—142 kg/m3 for a water-to-cement ratio of 0.33. The concrete test was conducted in accordance with SS-EN-934 test method for various polymers with the use of a polyalkylene oxide defoamer and prescribed amounts of gluconate and sucrose retarders. The polymer dosage is described as a percentage of weight of active polymer to weight of cement.

The mixing procedure was as follows: (1) mix sand, stone, and 50% of water for 30 seconds; (2) add the remaining water and mix for 30 seconds; (3) cement and mix for one minute; (3) add polymer and defoamer and mix for three minutes; (4) stop mixer and perform measurements immediately. The flow (in mm) is the average of two perpendicular diameters of concrete. The flow time (in second) is the time required for all the concrete to flow out of the cone using modified ASTM C143M-15a wherein the slump cone is placed upside down. The relative plastic viscosity (in 10⁻⁶ bar*h/m) is obtained by using a sliding pipe rheometer (Sliper), originally developed by Putzmeister and supplied by Schleibinger Testing Systems, Germany.

The results are shown in Table 2.

TABLE 2

| | | Properties at 5-min | | | Properties at 60-min | | |
|---|---|---|---|---|---|---|---|
| | | | | Rel. | | | Rel. |
| | | | | Plastic | | | Plastic |
| | | | Flow | Viscosity | | Flow | Viscosity |
| | Dosage | Flow | Time | (10⁻⁶ | Flow | Time | (10⁻⁶ |
| Admixture | (% s/c) | (mm) | (sec) | bar*h/m) | (mm) | (sec) | bar*h/m) |
| Polymer 1 | 0.11 | 410 | 6 | 3.2 | 300 | 18 | 4.0 |
| Polymer 2 | 0.08 | 400 | 5 | 2.8 | 298 | 13 | 2.9 |
| Reference | 0.10 | 400 | 12 | 5.9 | 300 | 53 | 5.5 |
| 1 | | | | | | | |

As shown in Table 2, while all three flow values are comparable, both Polymer 1 and Polymer 2 exhibited much shorter flow time and lower plastic viscosity than Reference 1. This demonstrated that the carboxylate polymers of the invention led to a reduction in stickiness.

### Example 3

In this example, the performance of the carboxylate polymers of the invention were evaluated at higher dosages and higher workability or flow. The test protocol was identical to that described in Example 2. The results are summarized in Table 3.

TABLE 3

| | | Properties at 5-min | | | Properties at 60-min | | |
|---|---|---|---|---|---|---|---|
| | | | | Rel. | | | Rel. |
| | | | | Plastic | | | Plastic |
| | | | Flow | Viscosity | | Flow | Viscosity |
| | Dosage | Flow | Time | (10⁻⁶ | Flow | Time | (10⁻⁶ |
| Admixture | (% s/c) | (mm) | (sec) | bar*h/m) | (mm) | (sec) | bar*h/m) |
| Polymer 1 | 0.15 | 510 | 17 | 9.9 | 475 | 30 | 11.6 |
| Polymer 2 | 0.13 | 520 | 16 | 11.6 | 455 | 20 | — |
| Reference | 0.11 | 520 | 26 | 12.7 | 475 | 35 | 14.1 |
| 3 | | | | | | | |

Again, the results in Table 3 confirm that the carboxylate polymers having two different polyether side chains outperformed the Reference polymer even at higher flow.

### Example 4

To demonstrate further the ability of the carboxylate polymer of the present invention to reduce the stickiness of concrete, the present inventors conducted another set of experiments using the same mix design and protocol of Example 2.

In addition to flow time and relative plastic viscosity, the inventors also measured penetration time. This measurement was performed by: (i) filling a slump cone with concrete, (ii) holding a tamping rod vertically at the center of the cone and touching the concrete surface, (iii) releasing the rod and allowing its weight to penetrate the concrete vertically, and (iv) measuring the time required for the tamping rod to reach bottom of the cone. The penetration time is believed to provide a simple indication of the concrete stickiness; it is also believed to reflect the flowability characteristic as well as the resistance characteristic (yield stress) of concrete to the tamping rod. Hence, the shorter the penetration time detected, the less sticky is the concrete. The results are shown below in Table 4.

TABLE 4

| | | Properties at 5-min | | | | Properties at 60-min | | | |
|---|---|---|---|---|---|---|---|---|---|
| | | | Flow | Penetration | Rel. Plastic | | Flow | Penetration | Rel. Plastic |
| | Dosage | Flow | Time | Time | Viscosity | Flow | Time | Time | Viscosity |
| Admixture | (% s/c) | (mm) | (sec) | (sec) | (10⁻⁶ bar*h/m) | (mm) | (sec) | (sec) | (10⁻⁶ bar *h/m) |
| Polymer 1 | 0.135 | 550 | 29 | 16 | 8.0 | 420 | 50 | 16 | 11.1 |
| Reference 2 | 0.120 | 535 | 47 | 22 | 24.4 | 415 | 120 | 41 | 23.0 |

It is clear from Table 4 that Polymer 1 of the invention exhibited significantly shorter flow time, shorter penetration time as well as lower viscosity compared to the reference polymer at 5-minute and at 60-minute marks.

These results again demonstrate that Polymer 1 of the present invention reduced the stickiness of concrete.

### Example 5

This example compares the concrete stickiness using a 50/50 mixture by weight of Polymer 1 and Polymer 2 of the invention versus Reference 2 polymer. The test protocol described in Example 2 was employed, except that the water to cement ratio was increased to 0.356 and no retarders were used. Instead of penetration time, V-funnel time was measured in this example. V-funnel time is defined as the time required for all the concrete flow through the V-funnel in accordance to test method EN 12350-9. The properties at 5-minute and 30-minute marks are depicted in Table 5.

TABLE 5

| | | Properties at 5-min | | | | Properties at 30-min | | | |
|---|---|---|---|---|---|---|---|---|---|
| | | | Flow | V-Funnel | Rel. Plastic | | Flow | V-Funnel | Rel. Plastic |
| | Dosage | Flow | Time | Time | Viscosity | Flow | Time | Time | Viscosity |
| Admixture | (% s/c) | (mm) | (sec) | (sec) | (10⁻⁶ bar *h/m) | (mm) | (sec) | (sec) | (10⁻⁶ bar *h/m) |
| Polymers 1&2 | 0.114 | 540 | 3.6 | 10.1 | 2.6 | 500 | 4.3 | 13.2 | 2.6 |
| Polymers 1&2 | 0.132 | 615 | 3 | 9.6 | 2.1 | 495 | 5.9 | 12.3 | 3.1 |
| Reference 2 | 0.113 | 605 | 5 | 12.7 | 3 | 500 | 7.2 | 17.3 | 4.0 |

As shown in Table 5, the 50/50 mixture of Polymer 1 and Polymer 2 produced concrete having shorter flow time, shorter V-funnel time, and lower viscosity than Reference 2 polymer, again demonstrating its unique performance in reducing stickiness of concrete.

The principles, preferred embodiments, and modes of operation of the present invention are described in the foregoing specification. The invention is not to be construed as limited to the particular forms disclosed, since these are to be regarded as illustrative rather than restrictive.

It is claimed:

1. A method for making a hydratable cementitious composition, comprising:
combining with water, cement, and at least one carboxylate copolymer formed from the following monomer components (A), (B), (C), and optionally (D):
(A) a first polyoxyalkylene monomer represented by structural formula: 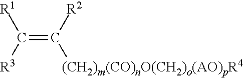
wherein R¹ and R² individually represent hydrogen atom or methyl group; R³ represents hydrogen or C(O)OM group wherein M represents a hydrogen atom or an alkali metal; AO represents oxyalkylene group having 2 to 4 carbon atoms or mixtures thereof; “m” represents an integer of 0 to 2; “n” represents an integer of 0 or 1; “o” represents an integer of 0 to 4; “p” represents an average number of oxyalkylene groups and is an integer from 5 to 35; and R⁴ represents a hydrogen atom or C₁ to C₄ alkyl group;
(B) a second polyoxyalkylene monomer represented by structural formula: 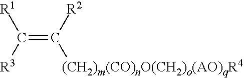
wherein R¹ and R² individually represent hydrogen atom or methyl group; R³ represents hydrogen or C(O)OM group wherein M represents a hydrogen atom or an alkali metal; AO represents an oxyalkylene group having 2 to 4 carbon atoms or mixtures thereof; “m” represents an integer of 0 to 2; “n” represents an integer of 0 or 1; “o” represents an integer of 0 to 4; “q” represents an average number of oxyalkylene groups and is an integer from 20 to 80; and R⁴ represents a hydrogen atom or C₁ to C₄ alkyl group;
(C) an unsaturated carboxylic acid monomer represented by structural formula: 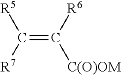
wherein R⁵ and R⁶ individually represent hydrogen atom or methyl group; R⁷ represents hydrogen atom, C(O)OM, C(O)OR8, or C(O)NH R⁸ wherein R⁸ represents a C₁ to C₄ alkyl group, and M represents a hydrogen atom or an alkali metal; and, optionally,
(D) an unsaturated, water-soluble monomer represented by structural formula: 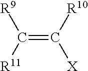
wherein R⁹, R¹⁰, and R¹¹ each independently represent a hydrogen atom, methyl group or C(O)OH; X represents C(O)NH₂, C(O)NHR¹², C(O)NR¹³R¹⁴, O—R¹⁵, SO₃H, C₆H₄SO₃H, or C(O)NHC(CH₃)₂CH₂SO₃H, or mixture thereof, wherein R¹², R¹³, R¹⁴, and R¹⁵ each independently represent a C₁ to C₅ alkyl group; and
wherein the molar ratio of component (A) to component (B) is from 15:85 to 85:15, and further wherein the molar ratio of component (C) to the sum of component (A) and component (B) is 90:10 to 50:50.

2. The method of claim 1 wherein the hydratable cementitious mixture contains sand aggregates.

3. The method of claim 2 wherein the hydratable cementitious mixture contains stone aggregates.

4. The method of claim 1 wherein the hydratable cementitious mixture is a concrete having a cement to concrete ratio of at least 340 kg/m³.

5. The method of claim 1 wherein the hydratable cementitious mixture is a concrete having a cement to concrete ratio of at least 400 kg/m³.

6. The method of claim 1 wherein, in the first polyoxyalkylene monomer of component (A), “p” is an integer of 8 to 30.

7. The method of claim 1 wherein, in the first polyoxyalkylene monomer of component (A), “p” is an integer of 10 to 25.

8. The method of claim 1 wherein, in the second polyoxyalkylene monomer of component (B), “q” is an integer of 20 to 65.

9. The method of claim 1 wherein, in the second polyoxyalkylene monomer of component (B), “q” is an integer of 25 to 50.

10. The method of claim 1 wherein, the sum of “p” in the first polyoxyalkylene monomer of component (A) and “q” in the second polyoxyalkylene monomer of component (B) is no more than 100.

11. The method of claim 9 wherein the sum of “p” in the first polyoxyalkylene monomer of component (A) and “q” in the second polyoxyalkylene monomer of component (B) is no more than 80.

12. The method of claim 1 wherein, the difference between “q” in the second polyoxyalkylene monomer of component (B) and “p” in the first polyoxyalkylene monomer of component (A) is an integer of at least 8.

13. The method of claim 1 wherein “m”, “n”, and “o” in component (A) or component (B) are integers of 0, 1, and 0, respectively.

14. The method of claim 1 wherein “m”, “n”, and “o” in component (A) or component (B) are integers of 1, 0, and 0, respectively.

15. The method of claim 1 wherein “m,” “n,” and “o” in component (A) or component (B) are integers of 2, 0, and 0, respectively.

16. The method of claim 1 wherein the first and second monomer components (A) and (B), the polyoxyalkylene is polyoxyethylene.

17. The method of claim 1 wherein the molar ratio of component (A) to component (B) is from 25:75 to 75:25.

18. The method of claim 1 wherein the molar ratio of component (A) to component (B) is from 35:65 to 65:35.

19. The method of claim 1 wherein the molar ratio of component (C) to the sum of component (A) and component (B) is 85:15 to 60:40.

20. The method of claim 1 wherein the molar ratio of component (C) to the sum of component (A) and component (B) is 80:20 to 67:33.

21. The method of claim 1 wherein the at least one carboxylate copolymer further comprises constituent groups derived from polymerization using component (D) monomer, and the molar ratio of constituent groups derived from component (D) to the sum of constituent groups derived from component (A), component (B), and component (C) is 1:99 to 20:80.

22. The method of claim 1 wherein the at least one carboxylate copolymer has a weight-average molecular weight of 8,000-50,000 as measured by using gel permeation chromatography using polyethylene glycol standards.

23. The method of claim 21 wherein the at least one carboxylate copolymer has a weight-average molecular weight of 10,000-40,000.

24. The method of claim 21 wherein the at least one carboxylate copolymer has a weight-average molecular weight of 12,000-30,000.

25. The method of claim 1 wherein the weight ratio of water to cement is less than 0.45.

26. The method of claim 1 wherein the weight ratio of water to cement is less than 0.40.

27. The method of claim 1 wherein the active amount of the carboxylate copolymer is from 0.08% to 0.30% by weight of cement.

28. The method of claim 25 wherein the active amount of the carboxylate copolymer is from 0.12% to 0.25% by weight of cement.

29. The method of claim 1 further comprising adding to the cement and water at least one additional admixture chosen from selected from the group consisting of gluconic acid or salt thereof, an alkanolamine, an air detraining agent, an air-entraining agent, and mixtures thereof.

30. The method of claim 1 wherein the at least one additional admixture is mixed with the carboxylate copolymer prior to combining with the cement and water.

31. A cementitious composition made by the method of claim 1.

32. An admixture for modifying hydratable cementitious compositions, comprising: at least one carboxylate copolymer formed from the following monomer components (A), (B), (C), and optionally (D):
(A) a first polyoxyalkylene monomer represented by structural formula: 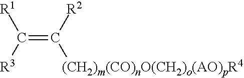
wherein R¹ and R² individually represent hydrogen atom or methyl group; R³ represents hydrogen or C(O)OM group wherein M represents a hydrogen atom or an alkali metal; AO represents oxyalkylene group having 2 to 4 carbon atoms or mixtures thereof; “m” represents an integer of 0 to 2; “n” represents an integer of 0 or 1; “o” represents an integer of 0 to 4; “p” represents an average number of oxyalkylene groups and is an integer from 5 to 35; and R⁴ represents a hydrogen atom or C₁ to C₄ alkyl group;
(B) a second polyoxyalkylene monomer represented by structural formula: 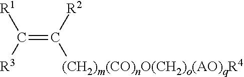
wherein R¹ and R² individually represent hydrogen atom or methyl group; R³ represents hydrogen or C(O)OM group wherein M represents a hydrogen atom or an alkali metal; AO represents an oxyalkylene group having 2 to 4 carbon atoms or mixtures thereof; “m” represents an integer of 0 to 2; “n” represents an integer of 0 or 1; “o” represents an integer of 0 to 4; “q” represents an average number of oxyalkylene groups and is an integer from 20 to 80; and R⁴ represents a hydrogen atom or C₁ to C₄ alkyl group;
(C) an unsaturated carboxylic acid monomer represented by structural formula: 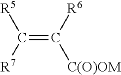
wherein R⁵ and R⁶ individually represent hydrogen atom or methyl group; R⁷ represents hydrogen atom, C(O)OM, C(O)OR8, or C(O)NH R⁸ wherein R⁸ represents a C₁ to C₄ alkyl group, and M represents a hydrogen atom or an alkali metal; and, optionally,
(D) an unsaturated, water-soluble monomer represented by structural formula: 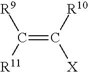
wherein R⁹, R¹⁰, and R¹¹ each independently represent a hydrogen atom, methyl group or C(O)OH; X represents C(O)NH₂, C(O)NHR¹², C(O)NR¹³R¹⁴, O—R¹⁵, SO₃H, C₆H₄SO₃H, or C(O)NHC(CH₃)₂CH₂SO₃H, or mixture thereof, wherein R¹², R¹³, R¹⁴, and R¹⁵ each independently represent a C₁ to C₅ alkyl group; and
wherein the molar ratio of component (A) to component (B) is from 15:85 to 85:15, and further wherein the molar ratio of component (C) to the sum of component (A) and component (B) is 90:10 to 50:50.
